(19) United States
(12) Patent Application Publication
(10) Pub. No.: US 2012/0020115 A1
(43) Pub. Date: Jan. 26, 2012

(54) Light Guide Board and Light Guide Key Board

(76) Inventor: Juncheng Guan, Shenzhen (CN)

(21) Appl. No.: 13/131,599

(22) PCT Filed: Nov. 2, 2009
(86) PCT No.: PCT/CN2009/074757

§ 371 Date: Oct. 14, 2011

(30) Foreign Application Priority Data
Nov. 27, 2008 (CN) 200820214034.0

(51) Int. Cl. F21V 8/00

(52) U.S. Cl. 362/616

(57) ABSTRACT

A light guide board comprises: a buffer layer (5), light guide plates (4) having a first surface injection molded on the buffer layer, a second surface having pressing points (1) with a buffer function, and a light scattering portion (3). A light guide key board includes the light guide board.

### TECHNICAL FIELD OF THE INVENTION

The present invention relates to components of electronic products, in particular to a light guide board and light guide key board.

### BACKGROUND OF THE INVENTION

Along with the development of the electronics industry towards super thin designs, the components of the electronic products are also developing in the same direction. However, the current light guide boards of portable electronic products are mainly formed by binding an injection molded PC board with a silica gel key board to achieve both the light guide function and good key feel; or the light guide board are formed by injection molding the liquid silica gel with an injection molded PC light guide board to combine the originally separated two portions. A product thus formed also has both the light guide function and good key feel. However, a light guide board formed by either of the above two methods tends to be too thick. Some products use light guide boards formed entirely from silica gel, but the light guide performance of a pure silica gel board is not desirable. The light conducted by such a light guide board from an LED light source is weak and not uniform and cannot meet the requirements of the products nowadays. A light guide board formed by coating silica gel on the back surface of a PC board with a thickness of 0.12 mm has a good light guide effect, but the PC board is hard and the material itself has a large tension, thus the feel of the keys of the product is not good, thus affecting the overall product performance.

### SUMMARY OF THE INVENTION

The present invention is directed to solve at least one problem associated with the prior art and provides a novel light guide board and light guide key board. The technical solution is as follows:

According to an embodiment of the present invention, a light guide board comprises a buffer layer, and a plurality of discrete light guide plates; each light guide plate has a first surface injection molded on the buffer layer, a second surface having injection molded pressing points having a buffer function, and a light scattering portion.

Preferably, the buffer layer has a hollow portion for containing a key, and the hollow portion has a continuous or discontinuous groove and a convex portion. The first surface of the light guiding plate is formed on the convex exterior surface of the hollow portion.

According to an embodiment of the present invention, a light guide key board comprises the above mentioned light guide plate and keys, the keys are fixed in a mirror image area where the mirror surface is a contact surface between the light guide board and the buffer layer.

The light guide board and light guide key board has the following advantages: a plurality of discrete light guide plates having light scattering portions are employed in the present invention, and the light guide plates need not be injection molded into the conventional shapes of light guide plates; the thickness of the light guide plates is decreased when compared with those prepared according to the conventional method. In this case, the uniformity of guided light can be ensured and the overall thickness of the light guide plate may be reduced. In the present invention, buffer layers or pressing points with a buffer function are set on both sides of the light guide plate to ensure the feel of the keys of the light guide board.

### BRIEF DESCRIPTION OF THE DRAWINGS

FIG. 1 illustrates a first example of the present invention.

FIG. 2 illustrates a second example of the present invention.

### REFERENCE NUMERALS

1 pressing point

2 hollow containing portion

3 light scattering portion

4 light guide plate

5 buffer layer

### DETAILED DESCRIPTION OF THE EMBODIMENTS

The technical characteristics, advantages as well as the objects of the present invention can be further understood in conjunction with the following description and drawings.

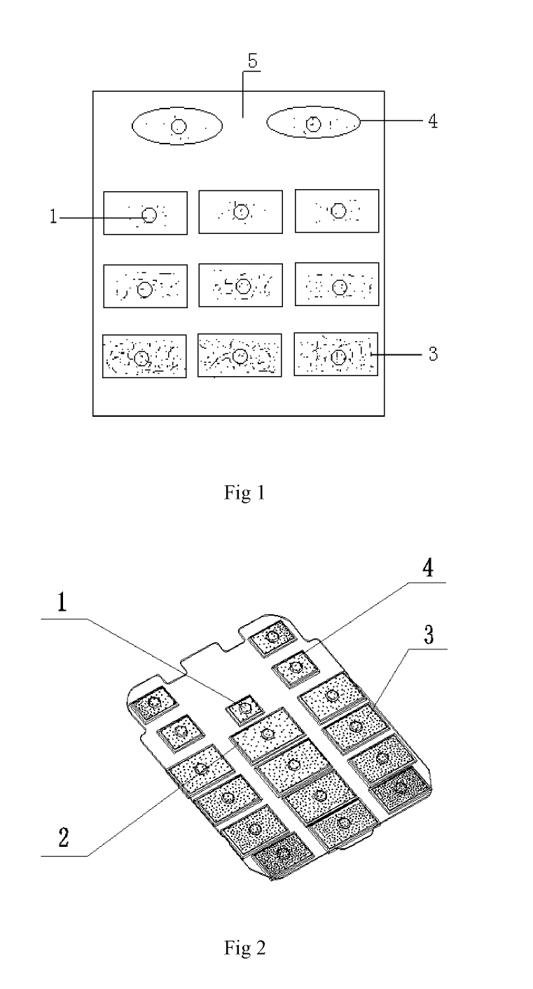

FIG. 1 illustrates a light guide board according to a first example of the present invention. Referring to FIG. 1, this example of the present invention is described as follows. The light guide board in the present example comprises a buffer layer 5 and a plurality of discrete light guide plates 4. Each light guide plate 4 has a first surface and a second surface, and a light scattering portion 3. The first surface of the light guide plate 4 is formed on the buffer layer 5 by injection molding. Pressing points 1 which have a buffer function are formed on the second surface of the light guide plate 4 by injection molding. The buffer layer 5 can be formed by silica gel or other types of transparent or white gel which has high light transmittance. Silica gel is selected to form the buffer layer 5 in the present example. More preferably, the pressing points 1 are also formed by silica gel.

Further, in the present invention, the pressing points 1 may be formed by injection molding on the surface of each light guide plate 4 where the light scattering portion 3 is located or it may be formed on the surface of the light guide plate 4 where no light scattering portion 3 is located. In the present example, the pressing points 1 are preferred to be formed by injection molding on the surface of light guide plate 4 where the light scattering portion 3 is located. The light scattering portions each have a cone shape and have different heights. The number of the light scattering portions 3 is in a direct proportion relation with the distance between the light guide plate and a light source. The light scattering portions 3 may be concave or convex portions set on the light guide plates 4. In the present example, the light scattering portions 3 are preferred to be concave portions on the light guide plates 4. Each light guide plate is formed from polycarbonate (PC) which has high light transmittance. The average thickness of the PC light guide plate is about 0.08-0.2 mm. In the present example, the PC light guide plate 4 is preferred to have a thickness of 0.12 mm. A PC light guide plate with a thickness of 0.12 mm can satisfy cold press and ultra-thin performance requirements. The concave portions formed by cold pressing the PC light guide plates serve as the light scattering portions, the concave portions have a cone shape, and the heights of the cones are different. In this case, the light scattering performance may be better. As the light transmittance and the frequency of transmitted light of the PC light guide plate material may differ from plate to plate, bright areas and dark areas may be formed. To improve the uniformity of the transmitted light, more concave portions are formed on one end of the light guide plate that is farther from the light, and fewer concave portions are formed on the other end of the light guide plate that is closer to the light source. As shown in FIG. 1, the number of the concave portions is in a direct proportion relation with the distance between the light guide plate and the light source.

A cold-pressed PC plate is cut into discrete PC light guide plates according to the size of keys. The PC light guide plate has an interface layer. The interface layer is suitable for receiving liquid silica gel that is injection molded directly to increase the adhesion performance between the PC light guide plate and the silica gel. The interface layer is transparent and it has a thickness of about 5-10 um, which is negligible relative to the thickness of the light guide board. The pressing points are formed on the surface of the PC light guide plate on which light scattering portions are formed, resulting in improved feel for the keys of the light guide board according the present invention.

The light guide board of the present invention is mainly used as a light guide key board. The light guide key board comprises the above mentioned light guide board and keys. The keys are fixed in the mirror image area where the mirror surface is the contact surface between the light guide board and the buffer layer. When the light from the light source passes through the light guide board to the key, as the light emitting from the light guide board is uniform, the light emitting from the key is also uniform. Moreover, as the present light guide board has two layers of silica gel and relatively thin light guide plate, the light guide key board has good feel and is also very thin.

FIG. 2 illustrates a light guide board according to a second example of the present invention. Referring to FIG. 2, the second example is described as follows. The buffer layer 5 in the present example further comprises a hollow portion 2 which can house the keys. Preferably, the hollow portion 2 comprises two portions including continuous or discontinuous grooves at the edge of the hollow portion 2 and a convex portion formed thereof in the centre of the hollow portion 2. The light guide board has a first surface formed on the exterior surface of the convex portion of the hollow portion. The convex exterior surface of the hollow portion is equal to or slightly larger than the surface area of the light guide plate 4, such that it will be easy to fix the light guide plate 4 and also ensure an appealing appearance of the whole light guide board. Here, “Slightly larger” means that the surface area of the convex portion is 1%-10% larger than the light guide board. The surface area of the convex portion is in accordance with the key surface of the electronic product.

The light guide plate 4, the light scattering portion 3, and the pressing point 1 in the present example are the same as example 1 described above and their description will be omitted here.

A light guide key board formed from the light guide board of the present invention is also provided. The light guide key board comprises the light guide board as described above and the keys. The keys are fixed in the hollow portions. When the light from the light source passes through the light guide board to the keys, as the light emitting from the light guide board is uniform, the light emitting from the keys is also uniform. Moreover, as the present light guide board has two layers of silica gel and a relatively thin light guide plate, the light guide key board has good feel and is also very thin.

Now the working principle of the light guide board will be described in conjunction with FIG. 2, and the principle, as well as the advantages of the light guide board according to the present invention, will be better understood.

In the present example, an LED light is selected as the light source. While the LED light passes through the highly transparent silica gel and illuminates the PC light guide plate 4 which has concave portions 3, as the transparency of the material and the frequency of the transmitted light are different, the light transmitted through the high light intensity area will be brighter and in the low light intensity area the light will be darker. In this design, the concave portions 3 in the PC light guide plate closer to the LED light source are less densely distributed, while the concave portions 3 in the PC light guide plate farther from the LED light source are more densely distributed. But the densities of the concave portions 3 in the different areas of the PC light guide plate 4 are in direct proportion with the distances between the areas and the light source, and the depths of the concave portions 3 in different areas of the PC light guide plate 4 are different. Therefore, the light emitted from the light guide board is uniform. The whole light guide board is formed from silica gel and PC light guide plate by injection molding, so that the PC light guide plate 4 in the key board has inlaid key areas that form a unitary body with the silica gel and that the guided light is bright and uniform. It also ensures high light transmittance, and the silica gel portion ensures the feel of the key board after assembly. Therefore the light guide board of the present invention may have uniform light distribution, good feel and super thin configuration, and meets the current market requirements.

The above examples only described several embodiments of the present invention, and the description is detailed and specific. However, it shall not be considered as a limit of the present invention. Those who skilled in the field may have a lot of modifications and variations within the spirit of the invention which are still within the protection range of the present invention. Therefore, the protection range of the present invention shall be considered by the claims.

1. A light guide board comprising:
a buffer layer; and
a plurality of discrete light guide plates, each of which has a first surface injection molded on the buffer layer, a second surface having injection molded pressing points having a buffer function, and a light scattering portion.

2. The light guide board according to claim 1, wherein the average thickness of each light guide plate is about 0.08-0.2 mm.

3. The light guide board according to claim 1, wherein the pressing points are injection molded on the surface of the light guide plate that has the light scattering portion.

4. The light guide board according to claim 1, wherein the pressing points are injection molded on the surface of the light guide plate that does not have the light scattering portion.

5. The light guide board according to claim 1, wherein the light scattering portion of the light guide plate is set on a concave portion of the light guide plate-.

6. The light guide board according to claim 1, wherein the light scattering portion of the light guide plate is set on a convex portion of the light guide plate.

7. The light guide board according to claim 1, wherein the light guide plate is coated with an interface layer.

8. The light guide board according to claim 1, wherein said light scattering portions are cone-shaped but have different heights.

9. The light guide board according to claim 8, wherein the number of said light scattering portions is in a direct proportion to the distance between the light guide plate and the light source.

10. The light guide board according to claim 9, wherein said buffer layer has a hollow portion for containing a key, wherein the hollow portion has a continuous or discontinuous groove and a convex portion, and wherein the first surface of said light guiding plate is formed on the convex exterior surface of the hollow portion.

11. A light guide key board, comprising the light guide board of claim 9, said keys are fixed in a mirror image area where the mirror surface is a contact surface between the light guide board and the buffer layer.

12. (canceled)

13. A light guide key board, comprising the light guide board of claim 10 and a key fixed in the hollow portion.

14. The light guide board according to claim 8, wherein said buffer layer has a hollow portion for containing a key, wherein the hollow portion has a continuous or discontinuous groove and a convex portion, and wherein the first surface of said light guiding plate is formed on the convex exterior surface of the hollow portion.

15. A light guide key board, comprising the light guide board of claim 14 and a key fixed in the hollow portion.

16. The light guide board according to claim 2, wherein said buffer layer has a hollow portion for containing a key, wherein the hollow portion has a continuous or discontinuous groove and a convex portion, and wherein the first surface of said light guiding plate is formed on the convex exterior surface of the hollow portion.

17. A light guide key board, comprising the light guide board of claim 16 and a key fixed in the hollow portion.

18. The light guide board according to claim 1, wherein said buffer layer has a hollow portion for containing a key, wherein the hollow portion has a continuous or discontinuous groove and a convex portion, and wherein the first surface of said light guiding plate is formed on the convex exterior surface of the hollow portion.

19. A light guide key board, comprising the light guide board of claim 18 and a key fixed in the hollow portion.

20. A light guide key board, comprising the light guide board of claim 8 and keys, said keys are fixed in a mirror image area where the mirror surface is a contact surface between the light guide board and the buffer layer.

21. A light guide key board, comprising the light guide board of claim 1 and keys, said keys are fixed in a mirror image area where the mirror surface is a contact surface between the light guide board and the buffer layer.
